(19) United States
(12) Patent Application Publication
(10) Pub. No.: US 2011/0047511 A1
(43) Pub. Date: Feb. 24, 2011

(54) System and Method for Organizing and Managing Personal Contacts in a Contact List

(75) Inventors: Martin Essl, San Francisco, CA (US); Steve Colen, II, San Rafael, CA (US); Moataz A. Rashad Mohamed, San Ramon, CA (US); Christopher Patnoe, Palo Alto, CA (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/628,671

(22) Filed: Dec. 1, 2009

Related U.S. Application Data
(60) Provisional application No. 61/235,484, filed on Aug. 20, 2009.

(51) Int. Cl. G06F 3/048; G06F 1/16

(52) U.S. Cl. 715/836; 361/679.21

(57) ABSTRACT

A communications device is configured to allow a user to sort, organize, and manage a plurality of contacts in a contact list stored on the device. The device includes a display to display a multi-dimensional contact board. The user can move contact objects representing the contacts to desired locations on the multi-dimensional contact board. The device will categorize each contact object based on its location on the multi-dimensional contact board.

### RELATED APPLICATION

This application claims priority under 35 U.S.C. §119(e) from U.S. Provisional Patent Application 61/235,484 filed Aug. 20, 2009. The '484 application, entitled, “System and Method for Organizing and Managing Personal Contacts in a Contact List,” is incorporated herein by reference in its entirety.

### BACKGROUND

The present invention relates generally to communications devices, and particularly to communication devices having personal contact lists that identify one or more personal contacts for a user.

Many communication devices, such as cellular telephones, for example, employ a contact list. A contact list is a list in memory that allows a user to store and organize contact information for his or her personal contacts. The contact information typically includes the names of the user's friends, family, and colleagues, their addresses, and one or more telephone numbers where they may be reached. In some instances, the contact information also allows a user to store primary and secondary email addresses for the contacts. To enter this information, a user generally creates a new contact record for a given contact and enters the appropriate contact information. However, contact information may also be obtained by synchronizing one's contact list with those associated with an online service, such as a social networking site or an Instant Messenger, for example. To view contact information, the user navigates a hierarchical menu on the device until he or she reaches a desired contact, and then selects the contact's name to display the contact information for that person.

The number of personal contacts and connections that most people store in their communication device, or at least have access to, has increased greatly. This is partly because current devices allow users to synchronize their contact lists with other lists from a plurality of different sources. Therefore, the amount of information that must be stored or associated with the user's contacts is astonishing. Consumers want solutions that enable them to store their contact information in meaningful ways so that they can easily navigate the contact list to find particular contacts and share media and other information with one or more desired contacts. However, any such solution must also be easy to use and be visually appealing.

### SUMMARY

In one embodiment of the present invention, a communication device, such as a cellular telephone, for example, comprises a display, a memory, and a controller. The display may be a touch-sensitive display, and the memory stores both a contact list and a computer program that permits the user to sort, organize, and maintain a plurality of contacts in the contact list.

The controller is programmed to display a multi-dimensional contact board to a user, and to place a contact object on the contact board in an initial location. The contact object includes contact information associated with a personal contact in the contact list. Responsive to user input, the controller moves the contact object from the initial location to another location on the contact board. The controller then categorizes the contact object based on the spatial location of the contact object in the multi-dimensional contact board.

Therefore, in one embodiment of the present invention, a method of organizing one or more personal contacts in a contact list stored on a communication device is provided. The method comprises displaying a multi-dimensional contact board on a display of a communication device, placing a contact object in the multi-dimensional contact board, wherein the contact object represents a personal contact to be stored in a contact list, and categorizing the contact object, by the communication device, based on the location of the contact object in the multi-dimensional contact board.

In one embodiment, categorizing the contact object comprises associating the contact object with one or more contact categories based on the location of the contact object in the multi-dimensional contact board.

In another embodiment, the method further comprises categorizing the contact object into the one or more contact categories based on a distance of the contact object location to one or more predefined locations on the multi-dimensional contact board.

In another embodiment, the method further comprises categorizing the contact object into one or more sub-categories based on the location of the contact object in the multi-dimensional contact board.

In one embodiment, the method further comprises using touch input to increase or decrease an indicator representing a characteristic of the personal contact associated with the contact object relative to indicators representing corresponding characteristics of other personal contacts, and displaying the indicators of one or more personal contacts on the contact board.

In one embodiment, the method further comprises selecting one or more contacts from the contact list by drawing a box around one or more contact objects on the multi-dimensional contact board.

In some embodiments, the method may comprise storing a preferred communication method for each contact, automatically formatting a message according to the preferred communication method for each selected contact object, and transmitting the formatted message to the each of the contacts.

In one embodiment, the preferred communication delivery method defined by a first selected contact object is different than the preferred communication delivery method defined by a second selected contact object.

In some embodiments, the method may comprise filtering the selected contact objects to obtain a desired set of contact objects.

In some embodiments, the method may comprise retrieving one or more messages received from the contacts associated with the one or more selected contact objects.

In some embodiments, the method may comprise determining a current geographical location for one or more of the contacts associated with the selected contact objects based on information provided by the one or more contacts.

In one embodiment, the method further comprises moving a selected contact object from a current location in the multi-dimensional contact board to a new location in the multi-dimensional contact board, and re-categorizing the contact object based on the new location of the contact object in the multi-dimensional contact board.

In one embodiment, the method further comprises displaying the multi-dimensional contact board as a three-dimensional contact board.

The present invention also provides a communication device comprising a display to display a multi-dimensional contact board, a memory to store a personal contact list, and a controller. The controller is programmed to display the multi-dimensional contact board, place a contact object representing a personal contact to be stored in the contact list in the multi-dimensional contact board, and categorize the contact object based on a location of the contact object in the multi-dimensional contact board.

In one embodiment, the controller is configured to categorize the contact object by associating the contact object with one or more contact categories based on the location of the contact object in the multi-dimensional contact board relative to one or more predefined locations on the multi-dimensional contact board.

In another embodiment, the controller is configured to categorize the contact object into one or more sub-categories based on the location of the contact object in the multi-dimensional contact board.

In one embodiment, the controller is configured to vary an indicator representing a characteristic of the personal contact associated with the contact object relative to indicators of corresponding characteristics of other personal contacts based on touch input received from the user, and display the indicators of one or more personal contacts on the contact board.

In one embodiment, the controller is configured to organize the one or more contact objects in the multi-dimensional contact board based on a characteristic input by the user.

In one embodiment, the controller is configured to select one or more contacts from the contact list responsive to the user drawing a box around one or more contact objects on the multi-dimensional contact board.

In one embodiment, the controller is configured to store a preferred communication delivery method for each contact, automatically format a message according to the preferred communication delivery method for each selected contact object, and transmit the formatted message to the each of the contacts.

In some embodiments, the controller is configured to transmit a media file to a selected contact based on the preferred communication delivery method for the selected contact.

In one embodiment, the preferred communication delivery method for a first selected contact object is different than the preferred communication delivery method for a second selected contact object.

In one embodiment, the controller is configured to move a selected contact object from a current location in the multi-dimensional contact board to a new location in the multi-dimensional contact board responsive to user input, and re-categorize the contact object based on the new location of the contact object in the multi-dimensional contact board.

In one embodiment, the multi-dimensional contact board comprises at least a two-dimensional contact board.

### BRIEF DESCRIPTION OF THE DRAWINGS

FIG. 1 is a block diagram illustrating some components of a communication device configured to operate according to one embodiment of the present invention.

FIG. 2 is a perspective view illustrating a communication device configured to operate according to one embodiment of the present invention.

FIG. 3 illustrates a contact board displayed on a communication device according to one embodiment of the present invention.

FIG. 4 is a flow diagram illustrating a method of organizing the contacts in a contact list according to one embodiment of the present invention.

FIG. 5 illustrates a contact board displayed on a communication device according to another embodiment of the present invention.

FIG. 6 is a flow diagram illustrating a method of transmitting a message to contacts on the contact list according to one embodiment of the present invention.

FIG. 7 illustrates a contact board configured according to one embodiment of the present invention.

FIGS. 8A-8B illustrate a contact board configured according to another embodiment of the present invention.

FIG. 9 illustrates a contact board displayed on a communication device according to another embodiment of the present invention.

FIG. 10 shows perspective views of some exemplary types of communication device suitable to be configured according to one embodiment of the present invention.

### DETAILED DESCRIPTION

The present invention provides a method that allows a user of a communication device to organize, sort, and manage a plurality of contacts in a contact list stored on the user's communication device. The user may have entered the contact information for the contacts, or obtained the contact information by synchronizing the device with an online service that such as a social networking site. The present invention is particularly useful for portable communication devices having limited or relatively small display screen areas, such as cellular telephones, for example, but may be employed by any communication device having a display.

In one embodiment, the user's communication device displays a multi-dimensional contact board and one or more contact objects to the user. The multi-dimensional contact board comprises a 2 or 3-dimensional field displayed on the display. The contact objects contain the contact information for the personal contacts in the user's contact list. The user can organize the personal contacts by dragging and dropping each contact object at a desired location on the contact board. The spatial location on the display where a contact object is dropped defines how the user's device will categorize that contact object. So organized, the user can, for example, employ the contact list to send messages to one or more desired contact.

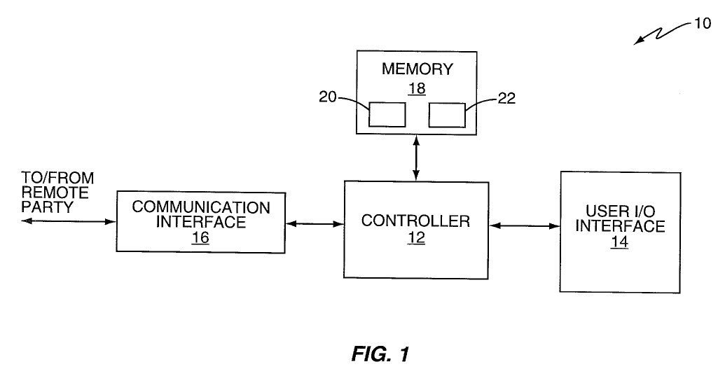

FIG. 1 is a block diagram illustrating some of the components of a communication device 10 configured to operate according to one embodiment of the present invention. Device 10, which in this embodiment is a cellular telephone, comprises a programmable controller 12, a user input/output interface 14, a communications interface 16, and a memory 18. As described in more detail later, memory 18 stores a computer program 20 or other set of computer-executable instructions that permit the user to organize the contact information for a plurality of contacts in the user's contact list 22.

Controller 12 generally controls the overall operation of device 10 according to programs and instructions stored in memory 18. The controller 12, which may be implemented in hardware, firmware, software, or a combination thereof, may comprise a single microprocessor or multiple microprocessors. The microprocessors may be general purpose microprocessors, digital signal processors, or other special purpose processors. The controller 12 executes the instructions in the computer program 20 to facilitate the user organizing the contacts in the user's contact list 22.

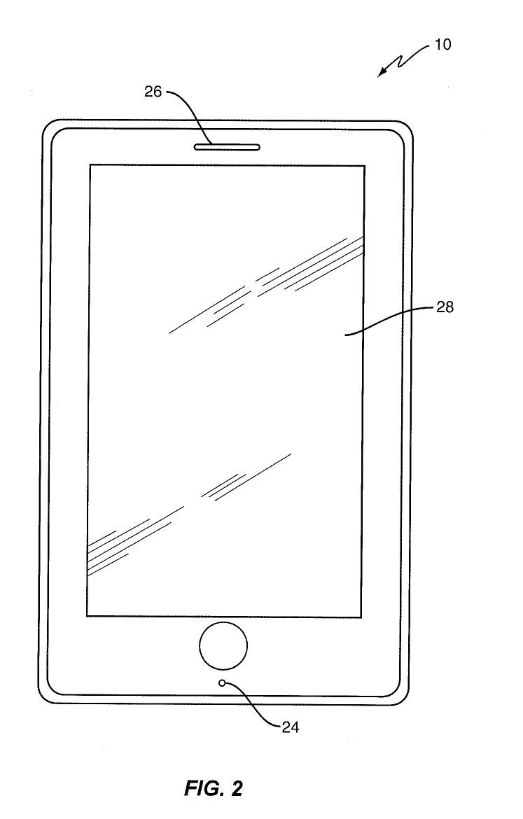

The User Interface (UI) 14 includes one or more user input devices and a display to enable the user to interact with and control the device 10. The UI 14 may include input/output devices such as a keypad, touchpad, joystick control dials, control buttons, display, speaker, microphone, or a combination thereof. For example, as seen in FIG. 2, one exemplary device 10 employs a microphone 24, a speaker 26, and a touch-sensitive display 28 as the UI 14. Although shown in the figures as such, a touch-sensitive display is not required for practicing the present invention. In fact, any type of display will do. However, the touch-sensitive display 28 is beneficial because it provides the user with the ability to view the contact information for a group of people in the contact list 22, as well as manage, sort, and organize that contact information, using only touch.

The communication interface 16 allows the device 10 to communicate messages and other data with one or more remote parties and/or devices. In this embodiment, the communication interface 16 comprises a fully functional cellular radio transceiver that can operate according to any known standard, including the standards known generally as the Global System for Mobile Communications (GSM), the General Packet Radio Service (GPRS), cdma2000, Universal Mobile Telecommunications System (UMTS), Wideband Code Division Multiple Access (WCDMA), 3GPP Long Term Evolution (LTE), and Worldwide Interoperability for Microwave Access (WiMAX). In other embodiments, however, the communication interface 16 may comprise a hardware port, such as an Ethernet port, for example, that connects device 10 to a packet data communications network. In yet another embodiment, the communication interface 16 may comprise a wireless LAN (802.11x) interface.

Memory 18 comprises a computer-readable medium that may include both random access memory (RAM) and read-only memory (ROM). Although not specifically shown, those skilled in the art will appreciate that the memory 18 also includes other hardware components, such as compact disks (CDs), hard drives, tapes, and digital video disks (DVDs). Computer program instructions and data required for operation are stored in non-volatile memory, such as EPROM, EEPROM, and/or flash memory, which may be implemented as discrete devices, stacked devices, or integrated with the controller 12.

As previously stated, memory 18 stores a contact list 22 that contains the contact information for one or more personal contacts, such as the user's friends and family. As is conventional, the contact information that may be stored includes a person's name, address and/or city where they live, their email address, their home and/or work phone numbers, and their mobile telephone numbers. However, other information may also be included, such as a contact category, or type of contact, to which the person belongs.

The number of personal contacts and connections that most people store in their communication device has increased greatly. This is at least partially due to the fact that most communication devices now permit users to synchronize their contact lists with other contact lists from many different sources. Although this allows a user to maintain an increased number of personal contacts, the amount of contact information that must be stored, organized, and maintained has also increased. Currently, many users access their contact lists via hierarchical menus; however, organizing and maintaining such large lists can be cumbersome.

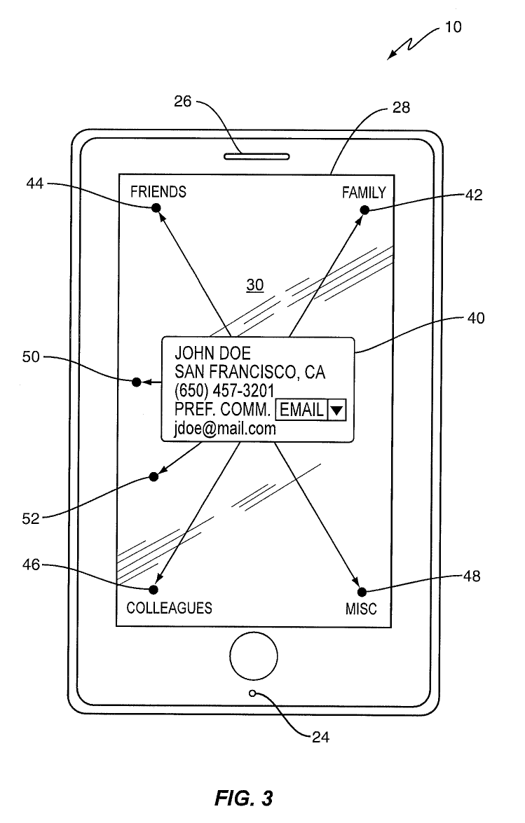

The present invention provides a user with an intuitive graphical user interface that permits users to organize, sort, and maintain the personal contacts in a contact list. FIG. 3 illustrates a device 10 configured to allow the user to visually organize and sort the different contacts in a contact list 22. As seen in FIG. 3, the controller 12 executes the computer program 20 to display a “contact board” 30. The contact board 30 is a multi-dimensional (e.g., a 2-dimensional or 3-dimensional) graphical user interface (GUI) representing a display field. Each corner of the contact board 30 is associated with a different pre-defined “contact category” to which a contact in the contact list 22 may be assigned. In this embodiment, the contact board 30 has four different categories identified by four different labels—“FAMILY,” “FRIENDS,” “COLLEAGUES,” and “MISCELLANEOUS.” However, as those skilled in the art will appreciate, other categories may be utilized in lieu of, or in addition to, the categories identified by the labels on display 28. Categories may be pre-defined by the manufacturer of the device 10 or by the user, and/or they may be added, deleted, and edited dynamically by the user.

The user's contacts are graphically represented on the contact board 30 as contact objects 40. A contact object 40 is a graphical symbol or icon that contains a variety of different contact information for a given contact. To organize the user's contacts, the controller 12 displays a contact object 40 at an initial location on a multi-dimensional contact board 30. In this embodiment, the initial location is substantially at the center point of the display 28, but may be anywhere on the display 28. To categorize the contact object 40, the user touches the contact object 40 with a finger, drags the contact object 40 from its initial location to a new desired location on the contact board 30, and drops the control object 40 at the new location. Based on the new location of the contact object 40, the controller 12 categorizes the contact object 40 as being associated with one or more of the categories identified by the labels on display 28.

For example, if a user were to touch contact object 40 and drag it along the line to the upper right corner 42, the controller 12 would categorize the contact object 40 as being “family,” and insert an appropriate indication into the contact information. Similarly, dragging the contact object 40 to the other corners 44, 46, or 48 would cause the controller to categorize the contact object 40 as being a “friend,” a “colleague,” or “miscellaneous,” respectively. In each case, the controller 12 would categorize the contact object for the user and place a corresponding indication in the contact information.

A given contact object 40 may also be assigned to multiple categories with a single drop of the contact object at a location between the corners 42-48. For example, in one embodiment, dragging the contact object 40 along the line and dropping it at a location 50 midway between corners 44, 46 would cause the controller 12 to categorize the contact object 40 as being both a “friend” and a “colleague.” To effect such multiple categorizations, the user need not drop the contact object 40 at the exact midpoint between the corners 44, 46. Rather, the user may drop the contact object 40 anywhere within a predefined threshold distance above and below the midpoint.

In another embodiment, the controller 12 could categorize contact objects 40 according to a weighting scheme. For example, the controller could assign each corner 42-48 an initial weight value that would vary (e.g., increase or decrease) with the distance from the corner. A user dragging the contact object 40 along a line and dropping it at a location 52 between corners 44 and 46 would still cause the controller 12 to categorize the contact object 40 as both a “colleague” and a “friend.” However, because the user dropped the contact object 40 closer to the “colleague” corner 46 than the “friend” corner 44, the controller 12 would categorize the contact object 40 as being more of a “colleague” than a “friend.” Thus, with the present invention, a user can assign multiple categories to a single contact object 40 in response to a single drop. Additionally, based on distance from one or more of the corners 42-48, the controller 12 can also weight the category assignment of a contact object 40 responsive to a single drop.

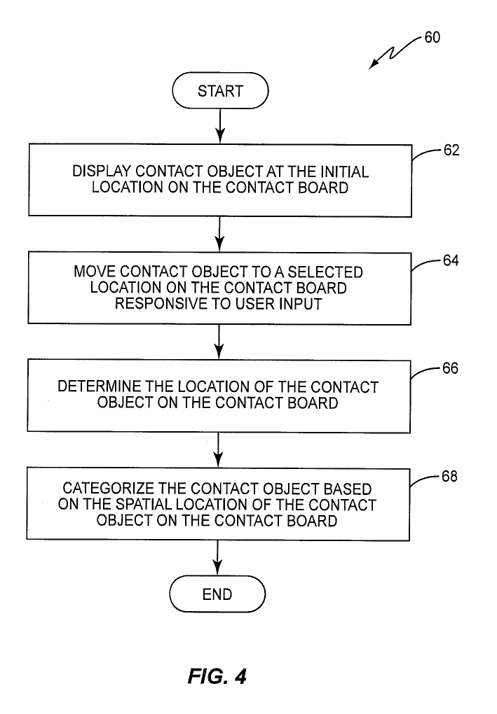

FIG. 4 is a flow chart illustrating a method 60 by which the controller 12 functions to allow the user to sort, organize, and maintain a contact list 22 according to one embodiment of the present invention. Method 60 begins with the controller 12 displaying the contact object 40 on the contact board 30 (box 62). The controller 12 may initially place each of one or more contact objects 40, one by one, onto the contact board 30 at any location; however, in this embodiment, the controller 12 initially places the one or more contact objects 40 at the center of the display 28. The user then touches the contact object 40 with a finger, for example, and moves the contact object 40 to a desired location on the contact board 30 (box 64). The controller 12 then determines the location of the contact object 40 on the contact board 30 (box 66) and categorizes the contact object 40 based on the spatial location of the contact object 40 (box 68).

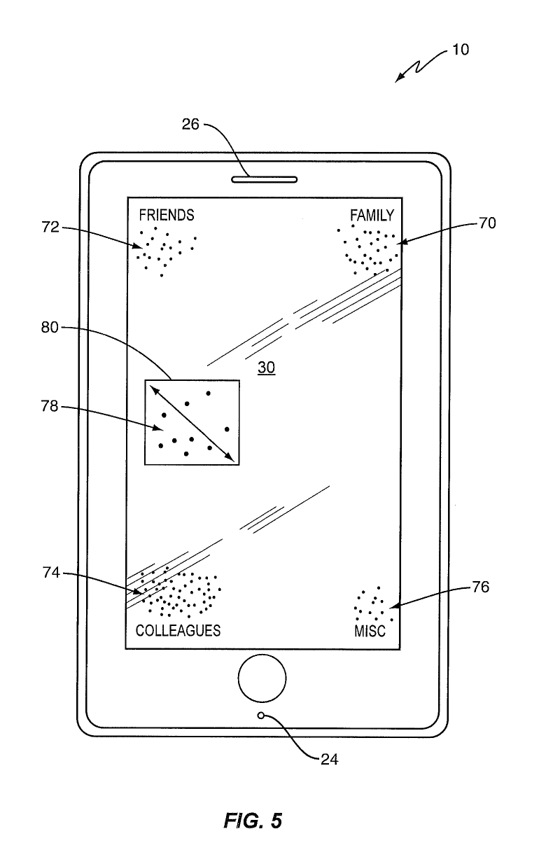

FIG. 5 illustrates an example of how a user may advantageously use the categorized contact objects 40 to perform certain functions, such as sending and receiving messages to one or more of the contacts. As seen in FIG. 5, the contact objects 40 on the contact board 30 have been categorized based on their location on the contact board 30. For example, the user's “family” is represented by a group of contact objects 70, the user's “friends” are represented by a group of contact objects 72, the user's “colleagues” are represented as a group of contact objects 74, and the “miscellaneous” contact objects are represented as a group of contact objects 76. Additionally, a group of contact objects 78 is located at various positions between the “friends” and “colleagues” labels. As described above, the contact objects in this group 78 have been categorized as both the user's “friends” and “colleagues”.

The user may send a message to certain contacts represented by the contact objects 40 on the contact boar, but will first have to select which contacts will receive the message. In this embodiment, the user selects a desired number of personal contacts using the touch-sensitive display 28. In one embodiment, the touch-sensitive display 28 employs multi-touch technology to select a group of contacts 70. Multi-touch technology is a well-known technology that those skilled in the art will readily appreciate how to implement. Therefore, no details regarding multi-touch technology are provided here. However, a brief discussion is included for completeness.

Multi-touch technology is a touch-based user interaction technique that permits users to control graphical applications such as the contact board 30 using one or more fingers. Multi-touch software, which may be included with or called by program 20, recognizes a single touch point on the display 28, or multiple simultaneous touch points on the display 28. The multi-touch software may recognize one or more touches by detecting any of a variety of things; however, some well-known methods include detecting heat, finger pressure, infrared light, optic capture, tuned electromagnetic induction, ultrasonic receivers, transducer microphones, laser rangefinders, and shadow capture.

In FIG. 5, the user can select the group of contacts 78 placing a thumb and forefinger, for example, in the center of the contacts in group 78. Then, while maintaining contact with the display 28, the user draws his or her fingers away from each other in the directions of the arrows. This motion causes the controller 12 to draw a selection box 80 on the display 28 that gets larger as the user continues to move his fingers away from each other. The user may stop when the selection box 80 fully encompasses the desired contact objects 78. The contact objects that are bounded by the selection box 80 are the selected contacts.

Once selected, a menu may appear on the display 28. The menu may present any number or type of options desired; however, in one embodiment, the menu presents the user with one or more options for generating and sending a message to a group of contacts. Some exemplary menu choices may be, for example,
Send SMS message to group
Send Email to group
Send IM to group
Create New Group
   The user can choose to perform any number of functions from the menu. For example, if the user wanted to write a message to the selected contacts in group 78, the menu selection would cause an editor application to launch so that the user could compose the message. Once the user was finished composing the message, the controller 12 would automatically add the data required to address the message to each of the contacts, and then send the message to only the selected contacts.

The “Create New Group” option could allow the user to name a plurality of contacts to reuse/re-address later on. For example, the user could create a “lunch group” comprising one or more contacts, and then select a preferred method of communication, such as email, for the members of that group. The user could then select the group as previously described and send an email to them inviting them to lunch. Once sent, the group may be dissolved either automatically or responsive to user input, or persist until such time as the user wishes to dissolve the group. The controller 12 could display such a “clustered” group as larger dot on the contact board 30 to distinguish this group from other contact objects.

Each contact in the group 78 would then receive the same message; however, not all contacts in the user's contact list receive messages using the same delivery method. For example, some users may prefer receiving Short Message Service (SMS) messages, while others prefer receiving email. Therefore, according to the present invention, the controller 12 automatically formats the message using the appropriate delivery method for each selected contact. Particularly, each selected contact object 40 in group 78 includes a field specifying a preferred contact type for the contact. The contact type specifies a preferred delivery method for the contact, and may be based, for example, on how the contact wishes to receive communications (e.g., via phone, SMS messaging, email, or to a social networking site). The controller 12 is programmed to automatically determine the delivery method needed to send a message to a given contact, and then generate and send the formatted message to the selected contact.

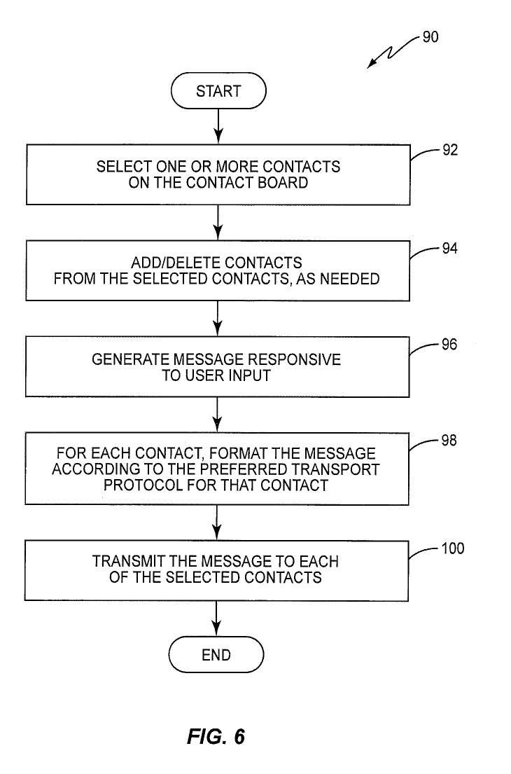

FIG. 6 is a flow diagram illustrating a method 90 of sending a group of selected contacts a message. Method 80 begins with the user selecting a group of contact objects 40 on the contact board 30 (box 92). Once selected, the user may optionally review the selected contacts and edit the list as needed or desired (box 94). For example, the user may remove contacts from the selected list or add new contacts to the selected list. Additionally, a user may, via a menu option, filter the selected contact objects to add or remove certain contacts based on criteria such as the contact's geographical location, the contact's phone number, or contact-specific information received from a social networking site. Other criteria include, but are not limited to, a specific contact type, and country code.

Once the user has identified all recipients, the controller 12 generates a message responsive to user input (box 96). Particularly, the controller 12 will review the contact information for each selected contact to determine the delivery method. The user's device 10 will then automatically generate the user's message according to the preferred delivery method for that contact (box 98), and sends the message to each selected contact (box 100). Thus, if a contact receiving the message is a FACEBOOK user, the generated message might automatically be formatted for, and sent to, the contact's FACEBOOK account. Similarly, the messages may be automatically formatted for, and sent to, a contact's email account depending upon that contact's protocol preference information stored in the contact object 40. Any protocol may be used to send and receive messages.

In addition to generating and sending messages and other communications to the contacts, the present invention may also be used to perform other functions. For example, a user could draw the selection box 82 around a group of contact objects on the contact board 30, and then view all status updates, text messages, instant messages, etc., related to the selected contacts. The user may also view the messages sent from the selected contacts, or send specific types of media (e.g., audio files, video files, etc.) to those selected contact that are able to receive and process certain types of media. Of course, the type of messages that device 10 formats and sends to a given contact depends on the capabilities of the receiving device, and how the contact object 40 for that contact specifies those capabilities. The user may also determine the current geographical location of the selected group of contacts using the present invention.

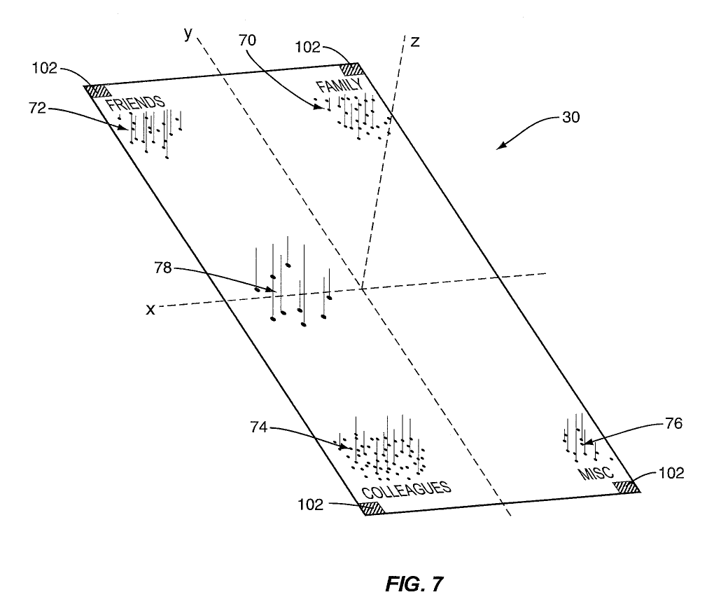

FIG. 7 illustrates an embodiment wherein the importance of different contact objects 40 may be graphically indicated to the user. In FIG. 7, the contact board 30 is shown having a plurality of touch-sensitive hot-spots 102 disposed at each corner. These areas 102 are associated with computer code that, when activated by the user's touch, causes the controller 12 to “tilt” the contact board 30 such that it appears as a 3-dimensional contact board 30 to the user. In this configuration, x, y, and z-axes may be overlaid onto the contact board 30 to provide a visual frame of reference for the user; however, it should be realized that these axes are not required by the present invention.

In FIG. 7, the categorized contact objects 40 are represented as dots with vertical lines extending upward from the plane of the contact board 30. The varying “heights” of the contact objects 40 can represent anything the user wishes. In this 3-D mode, for example, the varying heights of the lines represent the importance of a contact to the user. In another embodiment, however, the varying heights of the lines represent a frequency of communication between the user and the contact. For example, those contact objects having longer lines could represent contacts that the user communicates with more often (e.g., friends, family, close colleagues), while those having relatively smaller lines may represent contacts that the user communicates with less often.

The user may adjust the height of a given contact object 40 such that it appears larger or smaller on the contact board 30. For example, using multi-touch technology, “pinching” a given contact object 40 will cause the “vertical” column representing the contact object 40 to also contract and become smaller. Smaller columns lessen the importance of a contact object 40. Conversely, spreading apart the thumb and forefinger will tend to increase the importance of a contact object. Larger columns indicate contact objects that are more important to the user. Where multi-touch technology is not used, a user can simply touch the contact object 40, and then gesture up or down to increase or decrease the size of the column, and thus, the importance of the contact to the user.

The previous embodiments illustrated the contact board 30 as having four different categories. Thus, a user could categorize a given contact object 40 into one or more of any of the four different categories merely by placing the contact object at a desired location on the contact board 30. However, the present invention is not limited solely to having four categories. In another embodiment, one or more of the categories may have sub-categories that extend one or more hierarchical levels.

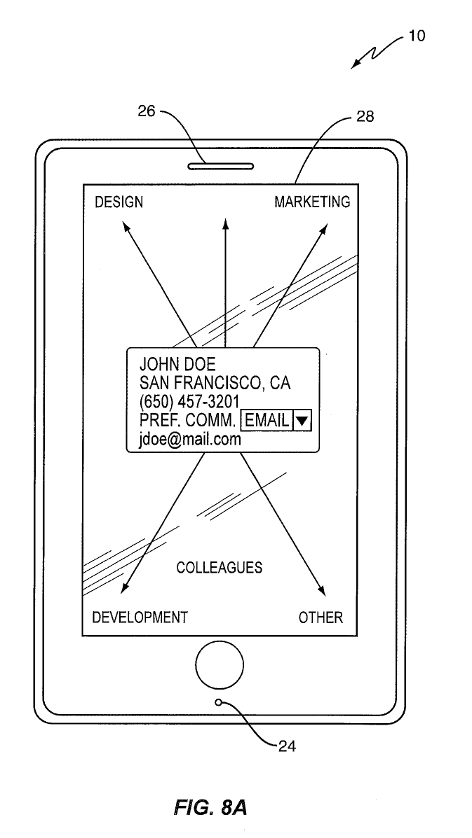

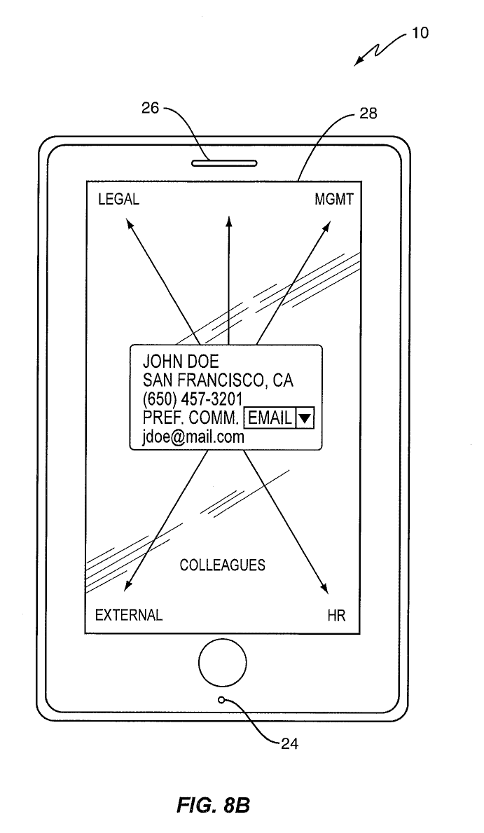

For example, as seen in FIG. 8A, the user may zoom-in on the “colleagues” area of the contact board 30 using multi-touch. Once zoomed in, the sub-categories for the “colleagues” category become apparent to the user. The contact sub-categories further classify the contact objects according to an area of specialization for the contact. Some exemplary sub-categories include “design,” “development,” “marketing,” and “other;” however, other labels are equally as suitable. With a single drop, a user could further categorize a given contact object 40 into one or more of these sub-categories as previously described.

Additionally, the present invention permits sub-categories of a given category to be arranged in one or more additional levels of sub-categories. For example, the user may zoom-in on the “other” sub-category using multi-touch to reveal another set of sub-categories, illustrated in FIG. 8B. The labels identifying the sub-categories in this new level may be, for example, “mgmt” (identifying management), “legal,” “hr” and “external.” As above, these sub-categories further classify the contact objects. With a single drop, a user could further categorize a given contact object 40 into one or more of these sub-categories as previously described. Although the figures show only two levels of sub-categories, the present invention is not so limited, and may be configured for additional levels as needed or desired.

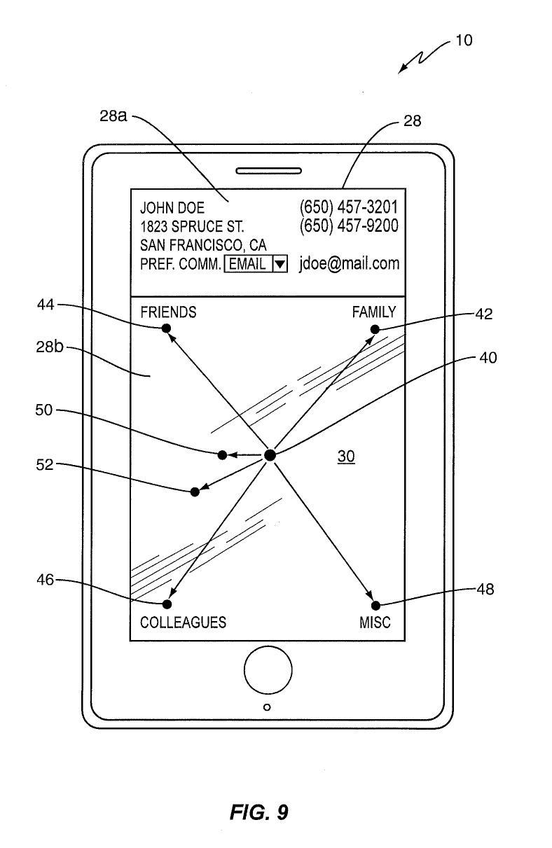

In the previous embodiments, the size of the contact board 30 corresponds to the size of the viewable display 28. However, the present invention is not so limited. FIG. 9 illustrates another embodiment wherein the display 28 is partitioned into two areas 28a, 28b. The top area 28a of the display 28 contains the text of the contact object 40 that is being classified by the user, while the bottom area 28b contains the contact board 30. The area 28a used to display the text is larger than the viewable area of a contact object 40, which makes it easier for a user to view more of the contact information for a given contact and/or edit that information. The contact object 40 is shown as being a dot at the center of contact board 30. The user would still classify the contact object 40 using a single drag and drop operation, as previously described, but a smaller representative dot might allow the user to classify the corresponding contact object 40 more accurately.

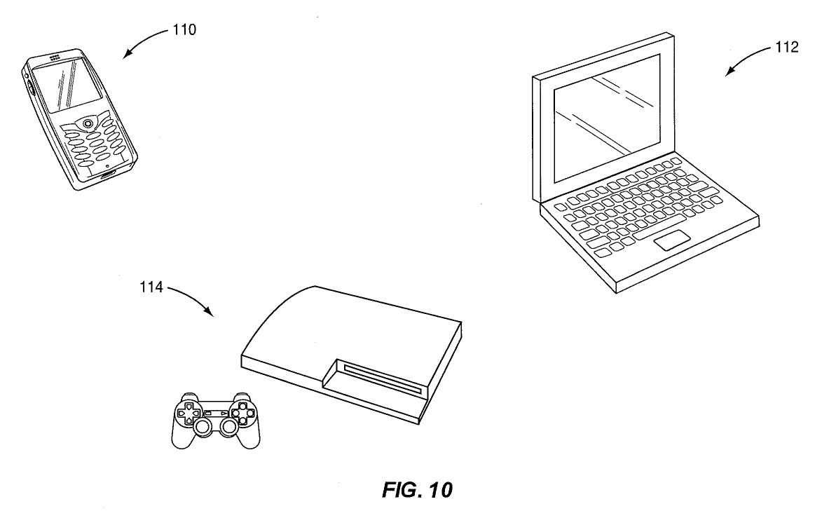

The present invention may, of course, be carried out in other ways than those specifically set forth herein without departing from essential characteristics of the invention. For example, the specification and drawings describe device 10 in terms of a cellular telephone having a touch-sensitive display screen. However, those skilled in the art should appreciate that the present invention is not limited solely to cellular telephones. FIG. 10 shows other consumer electronic devices that are suitable for use according to the present invention. Such devices include, but are not limited to, a Personal Digital Assistant (PDA) 110, a laptop or NetBook computing device 112, and a Game Console 114. In each case, these devices may be connected to a communication network and include a controller that may be programmed to allow a user to sort, organize, and maintain the contacts in a contact list 22 as previously described. Although not specifically shown, other suitable devices include, but are not limited to, Personal Navigation Devices, satellite phones and desktop computers.

The present embodiments are therefore to be considered in all respects as illustrative and not restrictive, and all changes coming within the meaning and equivalency range of the appended claims are intended to be embraced therein.

What is claimed is:

1. A method of organizing one or more personal contacts in a contact list stored on a communication device, the method comprising:
displaying a multi-dimensional contact board on a display of a communication device;
placing a contact object in the multi-dimensional contact board, wherein the contact object represents a personal contact to be stored in a contact list; and
categorizing the contact object, by the communication device, based on the location of the contact object in the multi-dimensional contact board.

2. The method of claim 1 wherein categorizing the contact object comprises associating the contact object with one or more contact categories based on the location of the contact object in the multi-dimensional contact board.

3. The method of claim 2 further comprising categorizing the contact object into the one or more contact categories based on a distance of the contact object location to one or more predefined locations on the multi-dimensional contact board.

4. The method of claim 2 further comprising categorizing the contact object into one or more sub-categories based on the location of the contact object in the multi-dimensional contact board.

5. The method of claim 1 further comprising:
using touch input to increase or decrease an indicator representing a characteristic of the personal contact associated with the contact object relative to indicators representing corresponding characteristics of other personal contacts; and
displaying the indicators of one or more personal contacts on the contact board.

6. The method of claim 1 further comprising selecting one or more contacts from the contact list by drawing a box around one or more contact objects on the multi-dimensional contact board.

7. The method of claim 6 further comprising:
storing a preferred communication method for each contact;
automatically formatting a message according to the preferred communication method for each selected contact object; and
transmitting the formatted message to the each of the contacts.

8. The method of claim 7 wherein the preferred communication delivery method defined by a first selected contact object is different than the preferred communication delivery method defined by a second selected contact object.

9. The method of claim 6 further comprising filtering the selected contact objects to obtain a desired set of contact objects.

10. The method of claim 6 further comprising retrieving one or more messages received from the contacts associated with the one or more selected contact objects.

11. The method of claim 6 further comprising determining a current geographical location for one or more of the contacts associated with the selected contact objects based on information provided by the one or more contacts.

12. The method of claim 1 further comprising:
moving a selected contact object from a current location in the multi-dimensional contact board to a new location in the multi-dimensional contact board; and
re-categorizing the contact object based on the new location of the contact object in the multi-dimensional contact board.

13. The method of claim 1 further comprising displaying the multi-dimensional contact board as a three-dimensional contact board.

14. A communication device comprising:
a display to display a multi-dimensional contact board;
a memory to store a personal contact list; and
a controller programmed to:
display the multi-dimensional contact board;
place a contact object representing a personal contact to be stored in the contact list in the multi-dimensional contact board; and
categorize the contact object based on a location of the contact object in the multi-dimensional contact board.

15. The device of claim 14 wherein the controller is configured to categorize the contact object by associating the contact object with one or more contact categories based on the location of the contact object in the multi-dimensional contact board relative to one or more predefined locations on the multi-dimensional contact board.

16. The device of claim 14 wherein the controller is further configured to categorize the contact object into one or more sub-categories based on the location of the contact object in the multi-dimensional contact board.

17. The device of claim 14 wherein the controller is further configured to:
vary an indicator representing a characteristic of the personal contact associated with the contact object relative to indicators of corresponding characteristics of other personal contacts based on touch input received from the user; and
display the indicators of one or more personal contacts on the contact board.

18. The device of claim 14 wherein the controller is further configured to organize the one or more contact objects in the multi-dimensional contact board based on a characteristic input by the user.

19. The device of claim 14 wherein the controller is further configured to select one or more contacts from the contact list responsive to the user drawing a box around one or more contact objects on the multi-dimensional contact board.

20. The device of claim 19 wherein the controller is further configured to:
store a preferred communication delivery method for each contact;
automatically format a message according to the preferred communication delivery method for each selected contact object; and
transmit the formatted message to the each of the contacts.

21. The device of claim 20 wherein the controller is further configured to transmit a media file to a selected contact based on the preferred communication delivery method for the selected contact.

22. The device of claim 24 wherein the preferred communication delivery method for a first selected contact object is different than the preferred communication delivery method for a second selected contact object.

23. The device of 14 wherein the controller is further configured to:
move a selected contact object from a current location in the multi-dimensional contact board to a new location in the multi-dimensional contact board responsive to user input; and
re-categorize the contact object based on the new location of the contact object in the multi-dimensional contact board.

24. The device of claim 14 wherein the multi-dimensional contact board comprises at least a two-dimensional contact board.
